(19) United States
(12) Patent Application Publication
(10) Pub. No.: US 2021/0116091 A1
(43) Pub. Date: Apr. 22, 2021

(54) VEHICLE LIGHT FIXTURE

(71) Applicant: ICHIKOH INDUSTRIES, LTD., Isehara-shi (JP)

(72) Inventor: Masateru HAYASHI, Kanagawa (JP)

(73) Assignee: ICHIKOH INDUSTRIES, LTD., Isehara-Shi (JP)

(21) Appl. No.: 17/041,117

(22) PCT Filed: Apr. 22, 2019
(86) PCT No.: PCT/IB2019/053298

§ 371 Date: Sep. 24, 2020

(30) Foreign Application Priority Data
Mar. 28, 2018 (JP) 2018-063022

(51) Int. Cl. F21S 41/19; F21S 41/33; F21S 45/47; F21S 41/148

(52) U.S. Cl. CPC F21S 41/19; F21S 41/148; F21S 45/47; F21S 41/337

(57) ABSTRACT

A vehicle light fixture includes: a reflector having a reflection surface; and a light source emitting light toward the reflection surface. The light source includes a first light emitting unit emitting light for low-beam light distribution, and a second light emitting unit emitting light for high-beam light distribution. The first light emitting unit is located at a focal point of the reflection surface. The second light emitting unit is located forward of the first light emitting unit, and is disposed so as to be offset from the first reference line toward a hot zone side of a low-beam light distribution pattern formed by light from the first light emitting unit on a screen. The first reference line extends through the focal point in the front-back direction. The reflection surface is formed in a surface shape that forms the low-beam light distribution pattern using light from the first light emitting unit.

### FIELD

The present invention relates to a vehicle light fixture.

### BACKGROUND

A vehicle light fixture is conventionally known that includes: a unit that controls light distribution of light from a light source for low beam with a reflector for forming a low-beam light distribution pattern and emits the light forward without interposing a projection lens; and a unit that controls light distribution of light from a light source for high beam with a reflector for forming a high-beam light distribution pattern (an additional light distribution pattern for high beam) and emits the light forward without interposing a projection lens (see Patent Literature 1).

### CITATION LIST

### Patent Literature

Patent Literature 1: Japanese Patent Application Laid-open No. 2017-68948

### SUMMARY

### Technical Problem

As described above, in such a vehicle light fixture that forms a low-beam light distribution pattern and a high-beam light distribution pattern with the design of parabolic reflection surfaces of the reflectors, different reflectors are used for different light distributions. As a result, there is a problem in that a large space is necessary and the vehicle light fixture is hard to be made smaller and lighter.

The present invention has been made in view of the circumstances, and it is an object of the present invention to provide a vehicle light fixture that performs light distribution control with a parabolic reflection surface of a reflector and that is capable of being made smaller and lighter.

### Solution to Problem

To achieve the object mentioned above, the present invention is understood by the following constitutions.

(1) A vehicle light fixture according to the present invention includes a reflector having a reflection surface that reflects light forward, and a light source that is disposed on an upper side or a lower side of the reflector and emits light toward the reflection surface. The light source includes a first light emitting unit that emits light for low-beam light distribution toward the reflection surface, and a second light emitting unit that emits light for high-beam light distribution toward the reflection surface. The first light emitting unit is located at a focal point of the reflection surface. The second light emitting unit is located forward of the first light emitting unit and is disposed so as to be offset from a first reference line toward a hot zone side of a low-beam light distribution pattern formed by light from the first light emitting unit on a screen, the first reference line extending through the focal point in a front-back direction. The reflection surface is formed in a surface shape that forms a low-beam light distribution pattern using the light from the first light emitting unit.
(2) In the configuration of the above (1), the second light emitting unit includes a plurality of second small light emitting units that stand side by side in a vehicle width direction with clearance interposed therebetween, and the second small light emitting units have a width in the vehicle width direction smaller than that of the first light emitting unit.
(3) In the configuration of the above (2), an angle θ is equal to or greater than 15 degrees and equal to or less than 50 degrees, and a distance D1 is shorter than a distance D2, where the angle θ is an angle of an oblique cutoff line of the low-beam light distribution pattern with respect to a horizontal reference line on the screen, the distance D1 is a shortest distance between the first reference line and a light emitting center of the second small light emitting unit closest to the first reference line, and the distance D2 is a shortest distance between a light emitting center of the second small light emitting unit farthest from the first reference line and the light emitting center of the second small light emitting unit closest to the first reference line.
(4) In the configuration of any one of the above (1) to (3), the second light emitting unit is positioned within a range of 3.0 mm forward of a second reference line that extends through the focal point in the vehicle width direction.
(5) In the configuration of any one of the above (1) to (4), the light source includes a light emitting module provided with the first light emitting unit and the second light emitting unit, the light emitting module having a first surface facing the reflection surface, and a board electrically connected to the light emitting module with ribbon bonding, the board provided with a feeder connector. The light emitting module includes a plurality of first bonding pads provided to the first surface, the first bonding pads disposed at positions that are closer to the second light emitting unit than the first light emitting unit is in the vehicle width direction and that are backward of the second light emitting unit, and at least one second bonding pad provided to the first surface, the second bonding pad disposed at a position that is closer to the first light emitting unit than the second light emitting unit is in the vehicle width direction and that is forward of the first light emitting unit. The ribbon bonding is performed such that a first ribbon is disposed backward from each of the first bonding pads, and that a second ribbon is disposed from the second bonding pad toward the vehicle width direction opposite to the second light emitting unit.

### Advantageous Effects of Invention

According to the present invention, the vehicle light fixture can be provided that performs light distribution control with the parabolic reflection surface of the reflector and that is capable of being made smaller and lighter.

### BRIEF DESCRIPTION OF DRAWINGS

FIG. 1 is a plan view of a vehicle provided with vehicle light fixtures according to an embodiment of the present invention.

FIG. 2 is a perspective view of main components of a light fixture unit according to the embodiment of the present invention.

FIG. 3 is an exploded perspective view for illustrating a light source according to the embodiment of the present invention.

FIG. 4 is a plan view of a portion of the light source according to the embodiment of the present invention when viewed from a reflection surface side of a reflector.

FIG. 5A is a view illustrating a low-beam light distribution pattern on a screen of a light-emitting module according to the embodiment of the present invention.

FIG. 5B is a view illustrating only the periphery of the light emitting module according to the embodiment of the present invention.

FIG. 6 is a view for illustrating a modification of the light source according to the embodiment of the present invention.

FIG. 7 is a view illustrating a high-beam light distribution pattern on the screen according to the embodiment of the present invention.

FIG. 8A is a view illustrating light distribution patterns formed on the screen by light from a second small light emitting unit according to the embodiment of the present invention.

FIG. 8B is a view illustrating light distribution patterns formed on the screen by light from another second small light emitting unit.

FIG. 9A is a view illustrating a light distribution pattern formed on the screen by light from a second ribbon according to the embodiment of the present invention.

FIG. 9B is a view illustrating a light distribution pattern formed on the screen by light from a first ribbon on a first light emitting unit side of first ribbons according to the embodiment of the present invention.

FIG. 9C is a view illustrating a light distribution pattern formed on the screen by light from the other first ribbon according to the embodiment of the present invention.

FIG. 10 is a view schematically illustrating a low-beam light distribution pattern.

FIG. 11 is a view for illustrating positional relations between a shoulder angle and the first light emitting unit and the second small light emitting units according to the embodiment of the present invention.

### DESCRIPTION OF EMBODIMENTS

Description of embodiments (hereinafter referred to as embodiments) will be given in detail below with reference to the accompanying drawings.

The same number or reference sign is given to the same components throughout the description of the embodiments.

In the embodiments and the drawings, “front”, “back”, “top”, “bottom”, “left”, and “right” refer to respective directions when viewed from a driver who rides on a vehicle unless otherwise noted.

Needless to say, “top” and “bottom” are also “top” and “bottom” in the vertical direction, and “left” and “right” are also “left” and “right” in the horizontal direction.

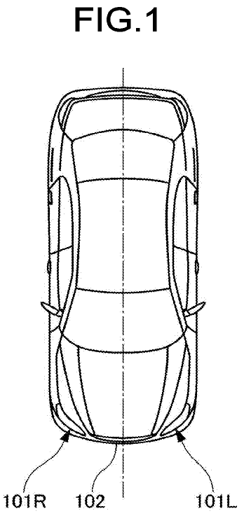

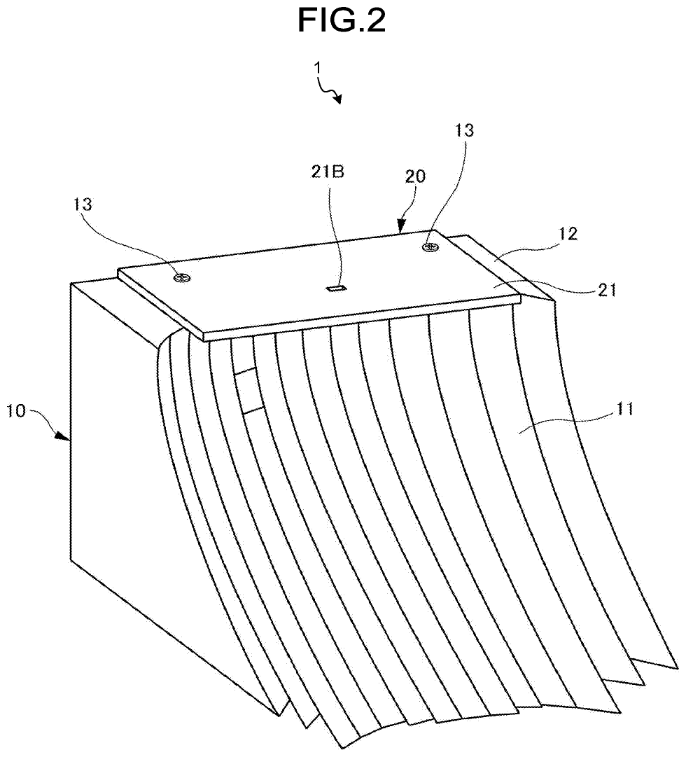

FIG. 1 is a plan view of a vehicle 102 provided with vehicle light fixtures according to an embodiment of the present invention. FIG. 2 is a perspective view of main components of a light fixture unit 1 according to the embodiment of the present invention.

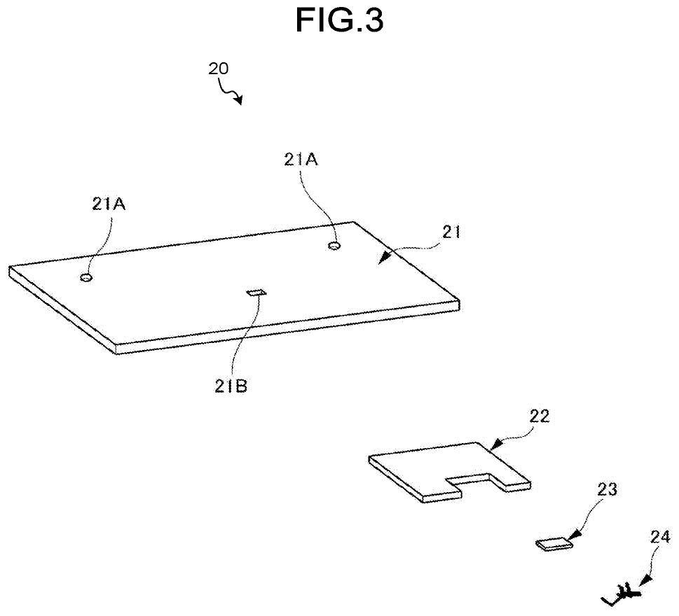

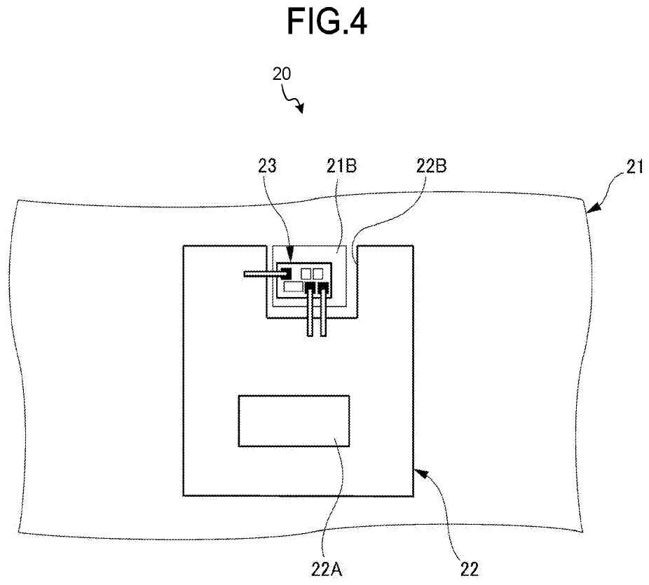

FIG. 3 is an exploded perspective view for illustrating a light source 20 according to the embodiment of the present invention. FIG. 4 is a plan view of a portion of the light source 20 according to the embodiment of the present invention when viewed from a reflection surface 11 side of a reflector 10.

As illustrated in FIG. 1, the vehicle light fixtures according to the embodiment of the present invention are headlights (101L, 101R) for a vehicle that are respectively provided to the left and right of the front of the vehicle 102, and are hereinafter simply referred to as the vehicle light fixtures.

The vehicle light fixtures of the present embodiment each include a housing (not illustrated) that is open forward of the vehicle and an outer lens (not illustrated) attached to the housing so as to cover the opening, and the light fixture unit 1 (see FIG. 2) and the like are disposed inside a lamp chamber formed by the housing and the outer lens.

The light fixture unit 1 mainly includes the reflector 10 having the reflection surface 11 that reflects light forward, and the light source 20 that is disposed on the upper side of the reflector 10 and that emits light toward the reflection surface 11, as illustrated in FIG. 2. The light fixture unit 1 is common to the left and right vehicle light fixtures.

However, the light fixture unit 1 may have an upside-down structure (an upside-down structure of FIG. 2), and, in this case, the light source 20 is disposed on the lower side of the reflector 10.

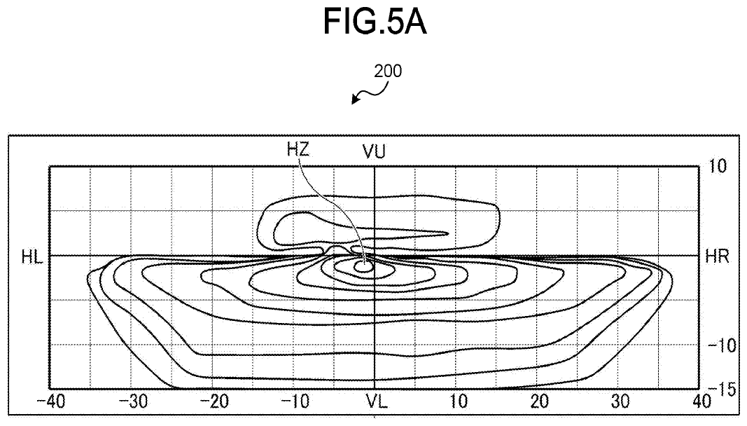

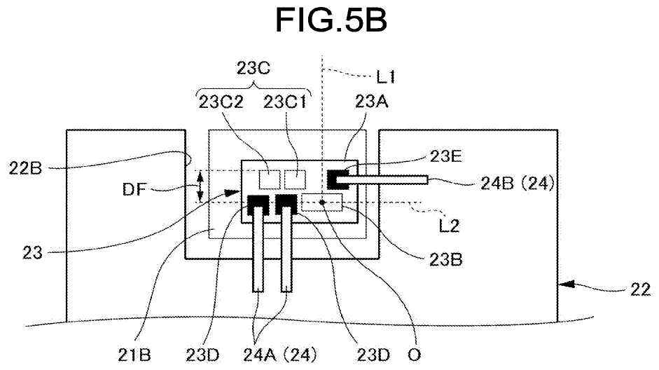

The reflection surface 11 has a parabolic shape as a whole, as illustrated in FIG. 2, and is formed of a free curved surface that controls light distribution to project, as a low-beam light distribution pattern, light from a first light emitting unit 23B (see FIG. 5) that emits light for low-beam light distribution, which will be described later, onto a screen directly without passing through a projection lens.

The light source 20 is attached to a top surface (see FIG. 2) of the reflector 10 (see FIG. 2), as illustrated in FIG. 3, and mainly includes a heat dissipating member 21 that functions as a heat sink, a board 22 (printed circuit board) that is disposed on the heat dissipating member 21, a light emitting module 23 that is disposed on the heat dissipating member 21, and a plurality of ribbons 24 for ribbon bonding by which the board 22 and the light emitting module 23 are electrically connected to each other.

The heat dissipating member 21 is a plate member the outside shape of which is rectangular and that is formed of a material having high heat dissipation, such as aluminum, for example.

The heat dissipating member 21 does not need to be limited to having a rectangular shape or to being a plate member. The heat dissipating member 21 may be such that necessary spots and the like have been subjected to bending processing, as appropriate.

The heat dissipating member 21 has a pair of left and right screw holes 21A through which screws are put, formed at positions near the left and right sides in the width direction (vehicle width direction).

Thus, through the screw holes 21A, screws 13 are screwed into screw threaded holes (not illustrated) formed on the top surface 12 of the reflector 10, as illustrated in FIG. 2, whereby the heat dissipating member 21 is attached to the reflector 10.

The heat dissipating member 21 also has a placing part 21B formed therein. The placing part 21B is located substantially in the center in the width direction (vehicle width direction), extrudes from the upper side toward the reflection surface 11 of the reflector 10 (see FIG. 2), and projects toward the reflection surface 11 at a position near the front in the front-back direction (vehicle front-back direction), as illustrated in FIG. 3. To this placing part 21B, the light emitting module 23, which will be described later, is bonded and fixed by an adhesive, for example.

The board 22 includes a feeder connector 22A to which feeder wiring for, for example, powering the light emitting module 23 from a battery or the like is connected. The feeder connector 22A is provided to the back side (vehicle back side) of a surface of the board 22 facing the reflection surface 11 (see FIG. 2) of the reflector 10 (see FIG. 2), as illustrated in FIG. 4.

The reflector 10 includes, on the top surface 12 thereof, a recess that is open backward, although the recess is not visible in FIG. 2. The recess houses the feeder connector 22A and serves as a path for connecting wiring to the feeder connector 22A.

The board 22 also includes, formed therein, a rectangular notch 22B that is open forward in order to dispose the placing part 21B. The board 22 is bonded and fixed to the heat dissipating member 21 by an adhesive, for example, so as to locate the placing part 21B in this notch 22B.

FIG. 5A and FIG. 5B are views for explaining the light emitting module 23. FIG. 5A is a view illustrating a low-beam light distribution pattern on a screen of the light-emitting module according to the embodiment of the present invention. FIG. 5B is a view illustrating only the periphery of the light emitting module according to the embodiment of the present invention.

Note that, of the light distribution patterns on the screen illustrated in FIG. 5A, the uppermost portion of the light distribution pattern having a small range is an overhead light distribution pattern, and the light distribution pattern having a large range below the overhead light distribution pattern is a low-beam light distribution pattern.

These light distribution patterns (the overhead light distribution pattern and the low-beam light distribution pattern) on the screen illustrated in FIG. 5A are formed by light from the first light emitting unit 23B, which will be described later, but the overhead light distribution pattern does not always need to be formed by the light from the first light emitting unit 23B.

Nevertheless, instead of using another light fixture unit to form the overhead light distribution pattern, it is preferable to utilize the light from the first light emitting unit 23B that emits light for a low-beam light distribution pattern so that the overhead light distribution pattern can also be formed together, because the vehicle light fixture as a whole can easily be made smaller and lighter.

Because FIG. 4 is a plan view when viewed from the reflection surface 11 side of the reflector 10 illustrated in FIG. 2, the left-to-right relation in FIG. 4 is not consistent with that in the direction when viewed from a driver who rides on the vehicle 102.

In other words, the left side in FIG. 4 is the right side in the direction when viewed from the driver who rides on the vehicle, and the right side in FIG. 4 is the left side in the direction when viewed from the driver who rides on the vehicle.

For this reason, the peripheral portion of the light emitting module 23 illustrated in FIG. 5B is depicted so as to reverse the left and right in FIG. 4 in order to achieve consistency of the positional relations.

Thus, for the peripheral portion of the light emitting module 23 in FIG. 5B, the left-right direction in FIG. 5B is consistent with the left-right direction when viewed from the driver who rides on the vehicle, although the heat dissipating member 21 is essentially located above the portion.

In other words, for the peripheral portion of the light emitting module 23, FIG. 5B is a view illustrating positional relations between members when the light source (see FIG. 2) is viewed from above in perspective view, and illustrates the positional relations between members in the paper plane direction when viewed from the reflection surface 11 side so as to clarify the state of ribbon bonding, for example.

In the view illustrating the low-beam light distribution pattern on the screen in FIG. 5A, a VU-VL line indicates a vertical reference line on the screen, a HL-HR line indicates a horizontal reference line on the screen, and the state of each light distribution pattern is indicated by an equi-intensity curve of light.

Hereinafter, views illustrating light distribution patterns on the screen are represented by equi-intensity curves of light, the VU-VL line indicates a vertical reference line on the screen, and the HL-HR line indicates a horizontal reference line on the screen.

As illustrated in FIG. 5B, the light emitting module 23 includes: a board 23A that is bonded and fixed to the placing part 21B; the first light emitting unit 23B that is provided to a first surface of the board 23A facing the reflection surface 11 (see FIG. 2) and that emits light for a low-beam light distribution pattern; and a second light emitting unit 23C that is provided to the first surface of the board 23A facing the reflection surface 11 (see FIG. 2) and that emits light for high-beam light distribution.

The first light emitting unit 23B is configured such that two light emitting diodes (LEDs) are formed on the first surface of the board 23A facing the reflection surface 11 (see FIG. 2) so as to be linked to each other in the left-right direction.

The first light emitting unit 23B is disposed in such a manner that the center of the first light emitting unit 23B is located substantially at a focal point O of the reflection surface 11 on the reflector 10 (see FIG. 2).

In FIG. 5A, a first reference line L1 extending through the focal point O in the front-back direction is shown by the dotted line, and, as can be seen from FIG. 5A, the first reference line L1 extends so as to overlap substantially the vertical reference line (see the VU-VL line) on the screen.

The light that has been emitted from the first light emitting unit 23B toward the reflection surface 11 (see FIG. 2) is subjected to light distribution control on the reflection surface 11 (see FIG. 2) so as to form a low-beam light distribution pattern on the screen, as described earlier, and is emitted forward. As illustrated in FIG. 5, the reflection surface 11 is formed in a surface shape that controls light distribution to form the low-beam light distribution pattern having a high luminous intensity zone (also referred to as a hot zone (HZ)) in which the luminous intensity is highest at a position to the left side of the vertical reference line (see the VU-VL line) by several degrees and to the lower side of the horizontal reference line (see the HL-HR line) by several degrees.

Meanwhile, the second light emitting unit 23C includes a plurality of second small light emitting units (a second small light emitting unit 23C1 and a second small light emitting unit 23C2) that stand side by side in the vehicle width direction (left-right direction in FIG. 5) with clearance interposed therebetween.

The second small light emitting unit 23C1 and the second small light emitting unit 23C2 both have an LED formed on the first surface of the board 23A facing the reflection surface 11 (see FIG. 2), and the second small light emitting unit 23C1 and the second small light emitting unit 23C2 have a width in the vehicle width direction (left-right direction in FIG. 5B) smaller than that of the first light emitting unit 23B.

As is the case with the first light emitting unit 23B, the second light emitting unit 23C may also be configured such that a plurality of LEDs are formed so as to be linked to each other in the left-right direction in such a manner that a range necessary as the second light emitting unit 23C can be covered. However, as in the present embodiment, two LEDs are separated from each other in the left-right direction, whereby a favorable high-beam light distribution pattern can be formed using a small number of elements.

The second light emitting unit 23C is located forward of the first light emitting unit 23B, as illustrated in FIG. 5B and is disposed so as to be offset from the first reference line L1 toward the hot zone HZ side of the low-beam light distribution pattern formed by the light from the first light emitting unit 23B on the screen.

As illustrated in FIG. 5B, the light emitting module 23 includes: a plurality of (two in the present example) first bonding pads 23D that are provided on the first surface of the board 23A facing the reflection surface 11 (see FIG. 2) and that stand side by side in the vehicle width direction (left-right direction in FIG. 5B); and at least one second bonding pad 23E that is provided to the first surface of the board 23A facing the reflection surface 11 (see FIG. 2). The first bonding pads 23D are disposed at positions that are closer to the second light emitting unit 23C than the first light emitting unit 23B is in the vehicle width direction (left-right direction in FIG. 5B) and that are backward of the second light emitting unit 23C. The second bonding pad 23E is disposed at a position that is closer to the first light emitting unit 23B than the second light emitting unit 23C is in the vehicle width direction (left-right direction in FIG. 5) and that is forward of the first light emitting unit 23B.

In this manner, the light emitting module 23 of the present embodiment includes the first light emitting unit 23B and the second light emitting unit 23C provided thereto and has the first surface facing the reflection surface 11 (see FIG. 2) (the first surface of the board 23A facing the reflection surface 11 (see FIG. 2)). The first surface has the first bonding pads 23D and at least one second bonding pad 23E formed thereon.

Of the first bonding pads 23D, the first bonding pad 23D near the first light emitting unit 23B is a positive pole for the first light emitting unit 23B, and the other first bonding pad 23D is a positive pole for the second light emitting unit 23C (the second small light emitting unit 23C1 and the second small light emitting unit 23C2). The second bonding pad 23E is a negative pole common to the first light emitting unit 23B and the second light emitting unit 23C (the second small light emitting unit 23C1 and the second small light emitting unit 23C2).

Thus, in the present embodiment, the first light emitting unit 23B and the second light emitting unit 23C (the second small light emitting unit 23C1 and the second small light emitting unit 23C2) can be lit or unlit (including electric power conditioning for adjustment of light amounts) individually, but the embodiment is not limited thereto. While second bonding pad 23E may be added serving as a negative pole for the second light emitting unit 23C (the second small light emitting unit 23C1 and the second small light emitting unit 23C2), two first bonding pads 23D may be provided corresponding to the second small light emitting unit 23C1 and the second small light emitting unit 23C2, so that the first light emitting unit 23B, the second small light emitting unit 23C1, and the second small light emitting unit 23C2 can be lit or unlit (including electric power conditioning for adjustment of light amounts) individually.

The board 22 (printed circuit board) to which the feeder connector 22A is provided and the light emitting module 23 are subjected to ribbon bonding using the ribbons 24, so as to be electrically connected to each other.

Specifically, as illustrated in FIG. 5B, ribbon bonding is performed in such a manner that the ribbons 24 (also referred to as first ribbons 24A) are disposed backward from the first bonding pads 23D, and that the ribbons 24 (the first ribbons 24A) are connected to the corresponding positive poles (the positive pole for the first light emitting unit 23B and the positive pole for the second light emitting unit 23C (the second small light emitting unit 23C1 and the second small light emitting unit 23C2)) of the board 22 (printed circuit board) to which the feeder connector 22A is provided.

Ribbon bonding is also performed in such a manner that a ribbon 24 (also referred to as a second ribbon 24B) is disposed from the second bonding pad 23E toward the vehicle width direction opposite to the second light emitting unit 23C (the right side in FIG. 5B), and that the ribbon 24 (the second ribbon 24B) is connected to a ground in the board 22 (printed circuit board) to which the feeder connector 22A is provided.

As described above, in the present embodiment, the light source 20 has a submount structure, and the light emitting module 23 is disposed directly on the heat dissipating member 21 serving as a heat sink. This enables heat generated by light emission from the first light emitting unit 23B and the second small light emitting units (the second small light emitting unit 23C1 and the second small light emitting unit 23C2) to be dissipated efficiently.

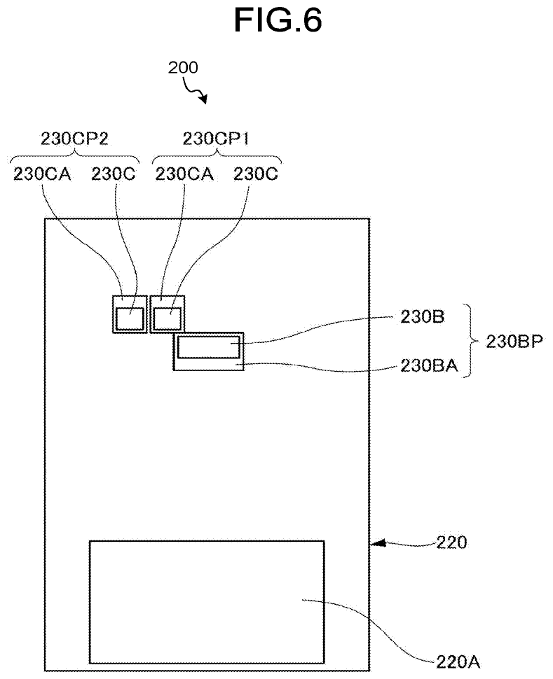

However, the present invention does not need to be limited to the light source 20 having a submount structure. The light source 20 may be a light source 200 of a modification illustrated in FIG. 6.

As is the case with FIG. 5B, FIG. 6 is also a view illustrating positional relations between members when the light source 200 is viewed from above in perspective view so that the left-right direction in FIG. 6 is consistent with the left-right direction when viewed from the driver who rides on the vehicle.

The light source 200 of the modification includes: a board 220 having a feeder connector 220A; a first light emitting unit 230B that is provided to a first surface of the board 220 facing the reflection surface 11 (see FIG. 2) of the reflector 10 (see FIG. 2) and that emits light for low-beam light distribution; and a second light emitting unit including a plurality of second small light emitting units 230C that are provided to the first surface, that emit light for high-beam light distribution, and that stand side by side in the vehicle width direction with clearance interposed therebetween.

Specifically, a first LED package 230BP is mounted on the first surface of the board 220. The first LED package 230BP has, on a board 230BA, the first light emitting unit 230B in which two LEDs that emit light for low-beam light distribution are formed so as to be linked to each other in the left-right direction. Further, a second LED package 230CP1 and a second LED package 230CP2 are mounted so as to stand side by side in the vehicle width direction (left-right direction in FIG. 6). The second LED package 230CP1 and the second LED package 230CP2 each has, on a board 230CA, the second small light emitting unit 230C in which one LED that emits light for high-beam light distribution is formed.

In this case, too, the first light emitting unit 230B and the second light emitting unit having the second small light emitting unit 230C have positional relations similar to those of the first light emitting unit 23B and the second light emitting unit 23C that has the second small light emitting unit 23C1 and the second small light emitting unit 23C2 described earlier.

In the case of the light emitting module 23 described earlier, the light emitting units are not packaged individually, the LEDs that constitute the second small light emitting unit 23C1 and the second small light emitting unit 23C2 are formed on the board 23A. This makes it easier to design the second small light emitting unit 23C1 and the second small light emitting unit 23C2 to have a small clearance therebetween.

Although there is no concern for such a light source 200 of the modification, the light source 20 excels in heat dispersion.

More detailed description will be given next including connections to light distribution patterns, for example.

As mentioned earlier, the reflector 10 has the reflection surface 11 formed in a surface shape that forms a low-beam light distribution pattern using the light from the first light emitting unit 23B, and the single reflector 10 having such a surface shape is also used to form a high-beam light distribution pattern. Consequently, the reflector 10 enables significant size reduction as well as weight reduction, compared with a case in which a reflector for a low-beam light distribution pattern and a reflector for a high-beam light distribution pattern are provided.

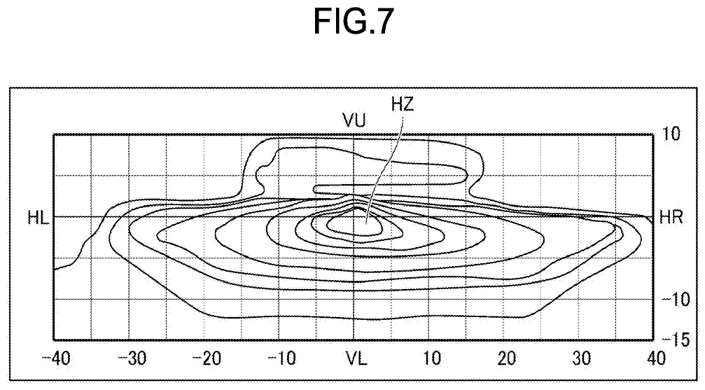

FIG. 7 is a view illustrating a high-beam light distribution pattern on the screen. In FIG. 7, a light distribution pattern formed by light from the second light emitting unit 23C that emits light for high-beam light distribution is multiplexed on the low-beam light distribution pattern illustrated in FIG. 5.

As illustrated in FIG. 7, in the high-beam light distribution pattern, a light distribution portion is present above the horizontal reference line (see the HL-HR line). Thus, as described earlier, the second light emitting unit 23C (the second small light emitting unit 23C1 and the second small light emitting unit 23C2) is disposed so as to be located forward of the first light emitting unit 23B.

As described earlier with reference to FIG. 5A, in the low-beam light distribution pattern, the hot zone HZ is located to the left side of the vertical reference line (see the VU-VL line) by several degrees and to the lower side of the horizontal reference line (see the HL-HR line) by several degrees, and is offset from the intersection of the vertical reference line (see the VU-VL line) and the horizontal reference line (see the HL-HR line).

Meanwhile, as illustrated in FIG. 7, in a high-beam light distribution pattern, the hot zone HZ includes the intersection of the vertical reference line (see the VU-VL line) and the horizontal reference line (see the HL-HR line).

Specifically, the reflector 10 (see FIG. 2) has a surface shape that controls light distribution to reflect, toward right forward, at least a part of light (a part of light emitted near the center on the screen, for example) emitted to the left side (the right side in FIG. 2) of the first reference line L1, which has been described earlier with reference to FIG. 5B, in the left-right direction when viewed from the driver who rides on the vehicle, and conversely, to reflect, toward left forward, at least a part of light (a part of light emitted near the center on the screen, for example) emitted to the right side (the left side in FIG. 2) of the first reference line L1 in the left-right direction when viewed from the driver who rides on the vehicle.

As described earlier with reference to FIG. 5B, the second light emitting unit 23C is disposed so as to be offset from the first reference line L1 toward the hot zone HZ side of the low-beam light distribution pattern formed by the light from the first light emitting unit 23B on the screen, so that the light is emitted to a position of the reflection surface 11 of the reflector 10 (see FIG. 2). The position is the left side (the right side in FIG. 2) of the first reference line L1 in the left-right direction when viewed from the driver who rides on the vehicle.

Thus, the high luminous intensity zone formed by the second light emitting unit 23C appears at a position shifted more to the right side on the screen than the high luminous intensity zone (the hot zone HZ in the low-beam light distribution pattern) formed by the first light emitting unit 23B illustrated in FIG. 5B, so that the hot zone HZ in the high-beam light distribution pattern includes the intersection of the vertical reference line (see the VU-VL line) and the horizontal reference line (see the HL-HR line), as illustrated in FIG. 7.

To be more precise, the second light emitting unit 23C is, as described earlier, located forward of the first light emitting unit 23B, so that, with respect to the hot zone HZ in the low-beam light distribution pattern, the high luminous intensity zone formed by the second light emitting unit 23C appears at a position shifted diagonally to the upper right, and the hot zone HZ in the high-beam light distribution pattern includes the intersection of the vertical reference line (see the VU-VL line) and the horizontal reference line (see the HL-HR line).

If the second light emitting unit 23C is located too forward, the hot zone HZ in the high-beam light distribution pattern is hard to be formed at the intersection of the vertical reference line (see the VU-VL line) and the horizontal reference line (see the HL-HR line). Thus, as illustrated in FIG. 5B, the second light emitting unit 23C is preferably positioned within a predetermined range DF forward of the second reference line L2 extending through the focal point (O) in the vehicle width direction, which is shown by the dotted line.

Specifically, the second light emitting unit 23C is preferably set so as to be positioned within a range of 3.0 mm forward of the second reference line L2.

In the present embodiment, the second light emitting unit 23C includes the second small light emitting unit 23C1 and the second small light emitting unit 23C2 so that a favorable hot zone HZ of a high-beam light distribution pattern can be formed easily.

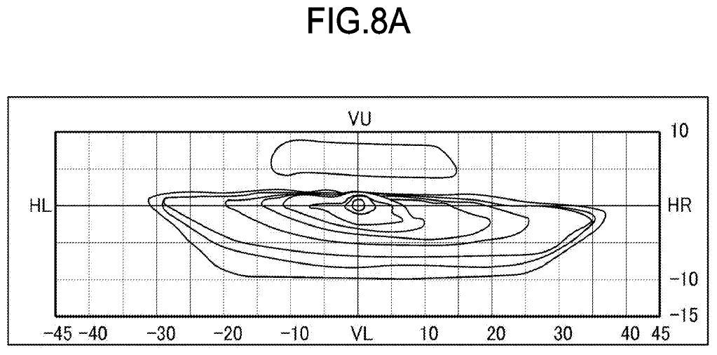

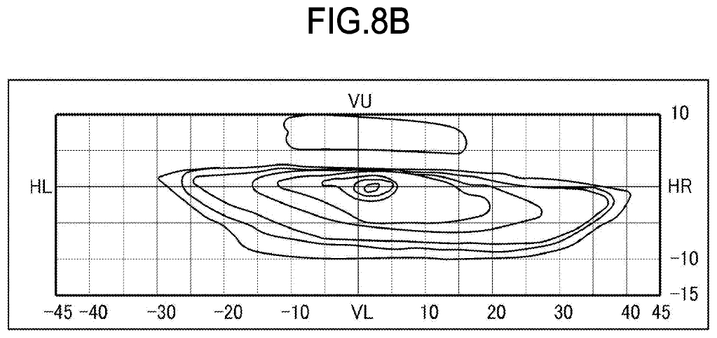

FIG. 8A and FIG. 8B are views illustrating light distribution patterns formed on the screen by light from the respective second small light emitting units (the second small light emitting unit 23C1 and the second small light emitting unit 23C2). FIG. 8A is a view illustrating a light distribution pattern on the screen formed by the light from the second small light emitting unit 23C1. FIG. 8B is a view illustrating a light distribution pattern on the screen formed by the light from the second small light emitting unit 23C2.

As illustrated in FIG. 8A, the second small light emitting unit 23C1 closest to the first reference line L1 illustrated in FIG. 5B makes the luminous intensity high at the intersection of the vertical reference line (see the VU-VL line) and the horizontal reference line (see the HL-HR line). As illustrated in FIG. 8B, the second small light emitting unit 23C2 farthest from the first reference line L1 illustrated in FIG. 5B makes the luminous intensity high at a position further to the right side of the intersection of the vertical reference line (see the VU-VL line) and the horizontal reference line (see the HL-HR line), whereby a favorable hot zone HZ that has sufficient luminous intensity and that also has a wide range in the high-beam light distribution pattern can be formed easily at the intersection of the vertical reference line (see the VU-VL line) and the horizontal reference line (see the HL-HR line).

In the present embodiment, because a case is described in which the vehicle 102 for left side travelling is supported, the hot zone HZ in the low-beam light distribution pattern is located to the left side of the vertical reference line (see the VU-VL line) by several degrees and to the lower side of the horizontal reference line (see the HL-HR line) by several degrees, while the second light emitting unit 23C is disposed so as to be offset from the first reference line L1 toward the hot zone HZ side of the low-beam light distribution pattern formed by the light from the first light emitting unit 23B on the screen, so that the light from the second light emitting unit 23C is emitted to the reflection surface 11 of the reflector 10 (see FIG. 2) to the left side (the right side in FIG. 2) of the first reference line L1 in the left-right direction when viewed from the driver who rides on the vehicle.

By contrast, in a case in which the reflector 10 supports the vehicle 102 for right side travelling, the hot zone HZ in the low-beam light distribution pattern is located to the right side of the vertical reference line (see the VU-VL line) by several degrees and to the lower side of the horizontal reference line (see the HL-HR line) by several degrees.

For such a case, it may be configured such that the second light emitting unit 23C is disposed so as to be offset from the first reference line L1 toward the hot zone HZ side of the low-beam light distribution pattern formed by the light from the first light emitting unit 23B on the screen, and the light from the second light emitting unit 23C is emitted to the reflection surface 11 of the reflector 10 (see FIG. 2) to the right side (the right side in FIG. 2) of the first reference line L1 in the left-right direction when viewed from the driver who rides on the vehicle.

Consequently, whether the vehicle 102 is for left side travelling or for right side travelling, there is no difference in that the second light emitting unit 23C is disposed so as to be offset from the first reference line L1 toward the hot zone HZ side of the low-beam light distribution pattern formed by the light from the first light emitting unit 23B on the screen.

Incidentally, in the present embodiment, an electric connection is established with ribbon bonding, as described earlier. Thus, it is necessary to avoid a glare by the ribbon 24 in use serving as a reflection part that reflects light toward the reflection surface 11 of the reflector 10 when the light from the ribbon 24 is reflected by the reflection surface 11.

At the same time, a small amount of light goes from the ribbons 24 serving as a reflection part toward the reflection surface 11, which enables the ribbons 24 to be utilized in order to alert oncoming vehicles and pedestrians by making the ribbons 24 reflect light properly.

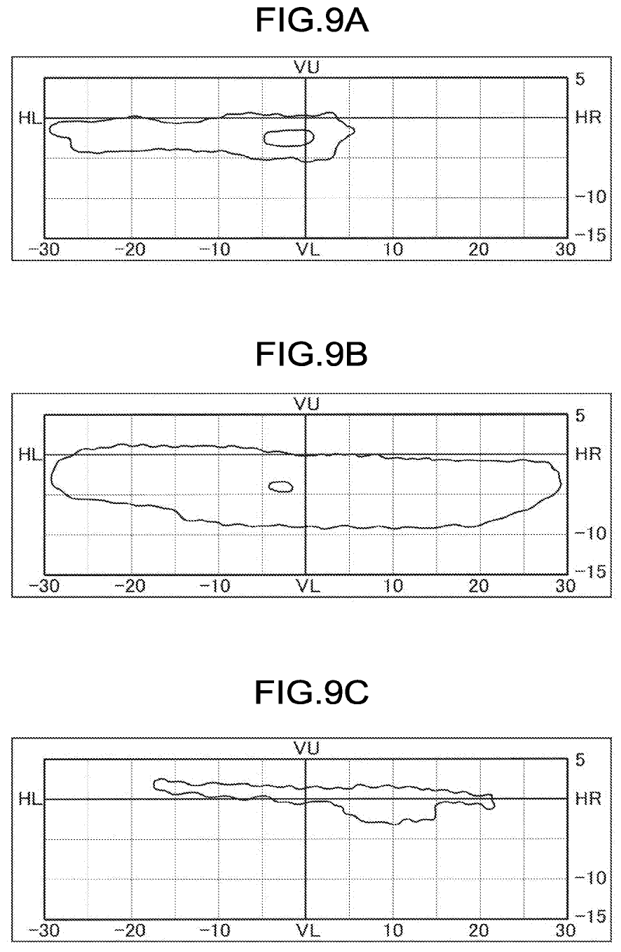

FIG. 9A to FIG. 9C are views illustrating light distribution patterns on the screen formed by light reflected from the ribbons 24 toward the reflection surface 11. FIG. 9A is a view illustrating a light distribution pattern formed on the screen by light from the second ribbon 24B. FIG. 9B is a view illustrating a light distribution pattern formed on the screen by light from the first ribbon 24A on the first light emitting unit 23B side of the first ribbons 24A. FIG. 9C is a view illustrating a light distribution pattern formed on the screen by light from the other first ribbon 24A.

As illustrated in FIG. 9A, with the disposition of the second ribbon 24B described earlier, in other words, by disposing from the second bonding pad 23E toward the vehicle width direction opposite to the second light emitting unit 23C (the right side in FIG. 5B), the distribution pattern as a whole is located on the left side, which reduces the glare given to oncoming vehicles.

The light from the second ribbon 24B has a portion with high luminous intensity to some extent. However, this portion with high luminous intensity is located below the horizontal reference line (see the HL-HR line), causing no glare, and only light that has low luminous intensity and is appropriate for an alert is located above the horizontal reference line (see the HL-HR line), and its range is also limited to being located slightly above the horizontal reference line (see the HL-HR line).

Likewise, as illustrated in FIG. 9B, for the light distribution pattern formed by the light from the first ribbon 24A on the first light emitting unit 23B side of the first ribbons 24A, the concerned ribbon 24A is disposed from the first bonding pads 23D backward, whereby only light that has low luminous intensity and is appropriate for an alert is located above the horizontal reference line (see the HL-HR line), and its range is also limited to being located slightly above the horizontal reference line (see the HL-HR line).

Furthermore, as illustrated in FIG. 9C, the light distribution pattern formed by the light from the other first ribbon 24A of the first ribbons 24A is located slightly above the horizontal reference line (see the HL-HR line) compared with that in FIG. 9B. However, the light distribution pattern is not located so much above, and only light that has low luminous intensity and is appropriate for an alert is located above the horizontal reference line (see the HL-HR line).

In this manner, disposing the ribbons 24 as described earlier reduces the glare while enabling light appropriate to alert oncoming vehicles and pedestrians to be emitted.

Meanwhile, by making the shape of the reflection surface 11 (see FIG. 2) side of the reflector 10 (see FIG. 2) for forming a low-beam light distribution pattern have an oblique cutoff line with great rise, such design is possible as to even more easily increase the luminous intensity at the intersection of the vertical reference line (see the VU-VL line) and the horizontal reference line (see the HL-HR line) in the hot zone HZ (see FIG. 7) of the high-beam light distribution pattern.

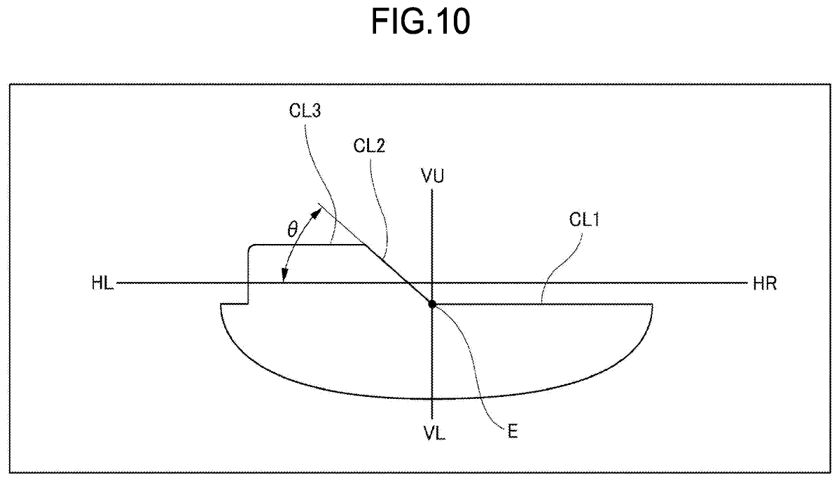

FIG. 10 is a view schematically illustrating a low-beam light distribution pattern, and description will be given with reference to FIG. 10. As illustrated in FIG. 10, the low-beam light distribution pattern has a lower horizontal cutoff line CL1, an oblique cutoff line CL2, and an upper horizontal cutoff line CL3. The lower horizontal cutoff line CL1 is located on the right side of the vertical reference line (see the VU-VL line). The oblique cutoff line CL2 extends diagonally to the upper left from an elbow point E that is located at the end on the left side of the lower horizontal cutoff line CL1 and is located substantially on the vertical reference line (see the VU-VL line). The upper horizontal cutoff line CL3 extends from the end on the left side of the oblique cutoff line CL2 to the left side.

When the angle of the oblique cutoff line C12 of the low-beam light distribution pattern with respect to the horizontal reference line (see the HL-HR line) is an angle θ (hereinafter also referred to as a shoulder angle), as the angle θ is greater, the oblique cutoff line C12 of the low-beam light distribution pattern has greater rise.

The reflection surface 11 (see FIG. 2) having great rise in the oblique cutoff line C12 of the low-beam light distribution pattern has greater light distribution control over the part of light emitted near the center on the screen described earlier.

This means that, even if the second small light emitting unit 23C1 is disposed close to the first reference line L1 illustrated in FIG. 5B, the luminous intensity at the intersection of the vertical reference line (see the VU-VL line) and the horizontal reference line (see the HL-HR line) can be increased, as described earlier, so that design is such that the second small light emitting unit 23C1 is brought closer to the first light emitting unit 23B.

In other words, this design means that the light from the first light emitting unit 23B becomes easier to be emitted to the intersection of the vertical reference line (see the VU-VL line) and the horizontal reference line (see the HL-HR line), and the design is such that the luminous intensity at the intersection is easily increased.

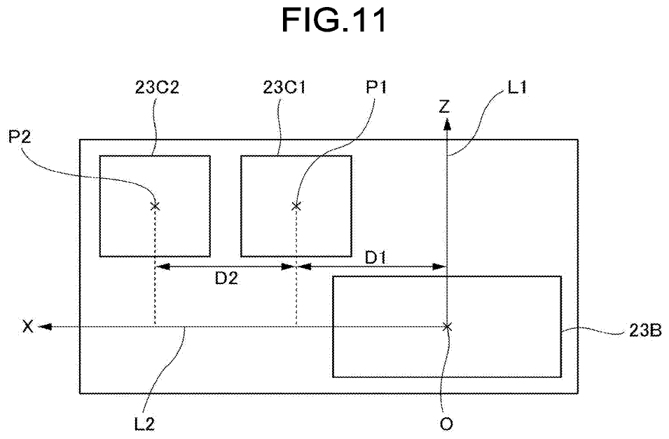

FIG. 11 is a view for illustrating positional relations between the shoulder angle and the first light emitting unit 23B and the second small light emitting units (the second small light emitting unit 23C1 and the second small light emitting unit 23C2).

In FIG. 11, the axis extending forward of the vehicle 102 along the first reference line L1 (see FIG. 5B) mentioned earlier with the focal point O serving as the origin is the Z axis, and the axis extending to the left side along the second reference line L2 (see FIG. 5) mentioned earlier with the focal point O serving as the origin is the X axis.

The shortest distance between the first reference line L1 and a light emitting center P1 of the second small light emitting unit 23C1 closest to the first reference line L1 is illustrated as a distance D1, and the shortest distance between a light emitting center P2 of the second small light emitting unit 23C2 farthest from the first reference line L1 and the light emitting center P1 of the second small light emitting unit 23C1 closest to the first reference line L1 is illustrated as a distance D2.

Let a position forward with the focal point O being Z=0 is represented by a positive numeric value (the unit is mm) and a position on the left side with the focal point O being X=0 is represented by a positive numeric value (the unit is mm). In a case in which the shoulder angle is 15 degrees, letting P1=(X=1.2, Z=1.2) and P2=(X=2.7, Z=1.2), in the second small light emitting unit 23C1, the luminous intensity at the intersection of the vertical reference line (see the VU-VL line) and the horizontal reference line (see the HL-HR line) can be increased, and, at the same time, in the second small light emitting unit 2302, the luminous intensity at a position further to the right side (a range of about 2.5 degrees to 5 degrees to the right side from the vertical reference line (see the VU-VL line)) from the intersection of the vertical reference line (see the VU-VL line) and the horizontal reference line (see the HL-HR line) can be increased.

Likewise, in a case in which the shoulder angle is from 20 degrees to 50 degrees, with P2 remaining P2=(X=2.7, Z=1.2), the luminous intensity in a range of about 2.5 degrees to 5 degrees to the right side from the vertical reference line (see the VU-VL line) can be increased.

Meanwhile, in a case in which the shoulder angle is from 20 degrees to 50 degrees, in order to efficiently increase the luminous intensity at the intersection of the vertical reference line (see the VU-VL line) and the horizontal reference line (see the HL-HR line) in the second small light emitting unit 23C1 accordingly, the position of P1 is preferably changed.

Specifically, in a case in which the shoulder angle is 20 degrees, 25 degrees, 30 degrees, 35 degrees, 40 degrees, 45 degrees, and 50 degrees, P1 is preferably (X=1.0, Z=1.2), (X=0.9, Z=1.2), (X=0.85, Z=1.2), (X=0.8, Z=1.2), (X=0.68, Z=1.2), (X=0.65, Z=1.2), and (X=0.55, Z=1.2), respectively.

In other words, when the shoulder angle (angle θ) is equal to or greater than 15 degrees and equal to or less than 50 degrees, which is the shoulder angle (angle θ) greater than that of a general low-beam light distribution pattern, the relation is preferably the distance D1<the distance D2 at all times.

For example, in a case in which the shoulder angle (angle θ) is 15 degrees, the distance D1=1.2 and the distance D2=1.5. In a case in which the shoulder angle (angle θ) is 20 degrees, the distance D1=1.0 and the distance D2=1.7.

In a case in which the shoulder angle (angle θ) is equal to or greater than 15 degrees and equal to or less than 50 degrees, the difference obtained by subtracting the distance D1 from the distance D2 is preferably equal to or greater than 0.3 mm. Likewise, in a case in which the shoulder angle (angle θ) is equal to or greater than 20 degrees and equal to or less than 50 degrees, the difference obtained by subtracting the distance D1 from the distance D2 is preferably equal to or greater than 0.7 mm.

Thus, with 15 degrees as a basis of the shoulder angle (angle θ), it is preferable to make setting to bring the second small light emitting unit 23C1 closer to the first reference line L1 so that the difference obtained by subtracting the distance D1 from the distance D2 is larger as the shape of the reflection surface 11 is changed to approach from the base shoulder angle (angle θ) to 50 degrees.

Although the present invention has been described above on the basis of the specific embodiment, the present invention is not limited by the embodiment mentioned above. Any embodiment to which the changes or improvements are made without departing from the technical idea is also included in the technical scope of the present invention, which is obvious to a person skilled in the art from the statement of the claims.

### REFERENCE SIGNS LIST

1 light fixture unit
10 reflector
11 reflection surface
12 top surface
13 screws
20 light source
21 heat dissipating member
21A screw holes
21B placing part
22 board
22A feeder connector
22B notch
23 light emitting module
23A board
23B first light emitting unit
23C second light emitting unit
23C1 second small light emitting unit
23C2 second small light emitting unit
23D first bonding pads
23E second bonding pad
24 ribbons
24A first ribbons
24B second ribbon
200 light source
220 board
220A feeder connector
230B first light emitting unit
230BA board
230BP first LED package
230C second small light emitting units
230CA board
230CP1 second LED package
230CP2 second LED package
CL1 lower horizontal cutoff line
CL2 oblique cutoff line
CL3 upper horizontal cutoff line
D1, D2 distances
DF range
E elbow point
HZ hot zone
L1 first reference line
L2 second reference line
O focal point
P1, P2 light emitting centers
101L, 101R headlights for a vehicle
102 vehicle

1. A vehicle light fixture comprising:
a reflector having a reflection surface that reflects light forward; and
a light source that is disposed on an upper side or a lower side of the reflector and emits light toward the reflection surface, wherein
the light source comprises
a first light emitting unit that emits light for low-beam light distribution toward the reflection surface, and
a second light emitting unit that emits light for high-beam light distribution toward the reflection surface,
the first light emitting unit is located at a focal point of the reflection surface,
the second light emitting unit is located forward of the first light emitting unit and is disposed so as to be offset from a first reference line toward a hot zone side of a low-beam light distribution pattern formed by light from the first light emitting unit on a screen, the first reference line extending through the focal point in a front-back direction, and
the reflection surface is formed in a surface shape that forms a low-beam light distribution pattern using the light from the first light emitting unit.

2. The vehicle light fixture according to claim 1, wherein
the second light emitting unit includes a plurality of second small light emitting units that stand side by side in a vehicle width direction with clearance interposed therebetween, and
the second small light emitting units have a width in the vehicle width direction smaller than that of the first light emitting unit.

3. The vehicle light fixture according to claim 2, wherein an angle θ is equal to or greater than 15 degrees and equal to or less than 50 degrees, and a distance D1 is shorter than a distance D2,
where the angle θ is an angle of an oblique cutoff line of the low-beam light distribution pattern with respect to a horizontal reference line on the screen,
the distance D1 is a shortest distance between the first reference line and a light emitting center of the second small light emitting unit closest to the first reference line, and
the distance D2 is a shortest distance between a light emitting center of the second small light emitting unit farthest from the first reference line and the light emitting center of the second small light emitting unit closest to the first reference line.

4. The vehicle light fixture according to claim 1, wherein the second light emitting unit is positioned within a range of 3.0 mm forward of a second reference line that extends through the focal point in the vehicle width direction.

5. The vehicle light fixture according to claim 1, wherein
the light source comprises
a light emitting module provided with the first light emitting unit and the second light emitting unit, the light emitting module having a first surface facing the reflection surface, and
a board electrically connected to the light emitting module with ribbon bonding, the board provided with a feeder connector,
the light emitting module comprises
a plurality of first bonding pads provided to the first surface, the first bonding pads disposed at positions that are closer to the second light emitting unit than the first light emitting unit is in the vehicle width direction and that are backward of the second light emitting unit, and
at least one second bonding pad provided to the first surface, the second bonding pad disposed at a position that is closer to the first light emitting unit than the second light emitting unit is in the vehicle width direction and that is forward of the first light emitting unit, and
the ribbon bonding is performed such that a first ribbon is disposed backward from each of the first bonding pads, and that a second ribbon is disposed from the second bonding pad toward the vehicle width direction opposite to the second light emitting unit.
